(19) United States
(12) Patent Application Publication
(10) Pub. No.: US 2020/0102918 A1
(43) Pub. Date: Apr. 2, 2020

(54) MARINE OUTBOARD MOTOR WITH EGR COOLER

(71) Applicant: COX POWERTRAIN LIMITED, Shoreham-By-Sea (GB)

(72) Inventors: Nile FULKER, Shoreham-By-Sea (GB); Nigel BOEILLE, Shoreham-By-Sea (GB); Matthew DICKERSON, Shoreham-By-Sea (GB)

(21) Appl. No.: 16/584,118

(22) Filed: Sep. 26, 2019

(30) Foreign Application Priority Data
Sep. 28, 2018 (GB) 1815934.3

(51) Int. Cl. F02M 26/30; F01N 3/02

(52) U.S. Cl. CPC F02M 26/30; F01N 2590/021; F01N 3/0205

(57) ABSTRACT

A marine outboard motor has an internal combustion engine including an engine block, at least one cylinder, an air intake configured to deliver a flow of air to the at least one cylinder and an exhaust conduit configured to direct a flow of exhaust gas from the at least one cylinder. The internal combustion engine also includes an exhaust gas recirculation system configured to recirculate a portion of the flow of exhaust gas from the exhaust conduit to the air intake. The exhaust gas recirculation system comprises a heat exchanger for cooling recirculated exhaust gas. The heat exchanger is removably integrated into the engine block.

### CROSS REFERENCE TO RELATED APPLICATIONS

This application claims priority to United Kingdom patent application no. 1815934.3, filed Sep. 28, 2019. The disclosure set forth in the referenced application is incorporated herein by reference in its entirety.

### FIELD OF THE INVENTION

The present invention relates to a marine outboard motor with an exhaust gas recirculation system including an EGR cooler or heat exchanger. While this application relates to marine outboard motors, the teachings may also be applicable to any other internal combustion engine.

### BACKGROUND OF THE INVENTION

At present, the outboard engine market is dominated by petrol engines. Petrol engines are typically lighter than their diesel equivalents. However, a range of users, from military operators to super-yacht owners, have begun to favour diesel outboard motors because of the improved safety of diesel fuel, due to its lower volatility, and to allow fuel compatibility with the mother ship. Furthermore, diesel is a more economical fuel source with a more readily accessible infrastructure for marine applications.

To meet current emissions standards, modern diesel engines for automotive applications typically use sophisticated charge systems, such as direct cylinder injection and turbocharging, to improve power output and efficiency relative to naturally aspirated diesel engines. With direct injection, pressurised fuel is injected directly into the combustion chambers. This makes it possible to achieve more complete combustion resulting in better engine economy and emission control. Turbocharging is commonly known to produce higher power outputs, lower emission levels, and improved efficiency compared to normally aspirated diesel engines. In a turbocharged engine, pressurised intake air is introduced into the intake manifold to improve efficiency and power output by forcing extra amounts of air into the combustion chambers. Turbocharged diesel engines typically take up more space than their normally aspirated equivalents. While this is generally not a problem in automotive applications, where there is often ample room for turbochargers in the engine bay, it can be problematic with marine outboard motors, in which the available space under the cowl can be extremely limited.

Modern diesel engines for automotive applications also typically employ exhaust gas recirculation (EGR) in order to reduce the gaseous emissions of oxides of nitrogen (NOx). NOx gases are produced from the reaction of nitrogen and oxygen during combustion, particular with high cylinder temperatures and pressures. In order to inhibit the generation of NOx gases, EGR systems redirect a portion of the exhaust gas back to the air intake of the engine to reduce the amount of oxygen supplied to the cylinders. The redirected exhaust gases are inert to combustion and act as absorbents of combustion heat. Consequently, the use of EGR can reduce peak temperatures and pressures in the cylinder and thereby reduce NOx emissions.

Since exhaust gases are much hotter than ambient air, steps should be taken to ensure that the intake charge temperatures are not unduly increased by the inclusion of hot exhaust gases which might otherwise reduce charging efficiency and thus performance. In automotive EGR systems, an EGR cooler, in the form of a heat exchanger connected to a coolant circuit, is typically used to cool the recirculated exhaust gas prior to delivery to the air intake. Such EGR coolers are separate from the engine block. As with the addition of a turbocharging system, the inclusion of an EGR cooler can increase the overall space occupied by the engine assembly. While this is generally viable in automotive applications, the inclusion of one or more EGR coolers can be problematic for marine outboard engines, in which the available space under the cowl can be extremely limited.

One solution to address the problem of packaging space when including an EGR cooler into a marine outboard engine is to incorporate the heat exchanger entirely within the walls of the engine block by casting a number of internal coolant and exhaust gas conduits within the walls of the engine block itself. This can severely restrict access to the heat exchanger for maintenance purposes and prevent replacement of the heat exchanger independently from the engine block. This can be particularly problematic for marine applications in which raw water, i.e. the untreated body of water on which the vessel is used, is employed as the coolant fluid, since the presence of salt and/or organisms in raw water can lead to additional fouling and necessitate more frequent cleaning or replacement of cooler components than might otherwise be required.

The present invention seeks to provide an improved marine outboard motor which overcomes or mitigates one or more problems associated with the prior art.

### SUMMARY OF THE INVENTION

According to a first aspect of the present invention, there is provided a marine outboard motor having an internal combustion engine, the internal combustion engine comprising: an engine block; at least one cylinder; an air intake configured to deliver a flow of air to the at least one cylinder; an exhaust conduit configured to direct a flow of exhaust gas from the at least one cylinder; and an exhaust gas recirculation system configured to recirculate a portion of the flow of exhaust gas from the exhaust conduit to the air intake, the exhaust gas recirculation system comprising at least one heat exchanger for cooling recirculated exhaust gas, wherein the at least one heat exchanger comprises a fixed part which is integral to the engine block and a removable part which is removably mounted on an external surface of the engine block, such that the at least one heat exchanger is removably integrated into the engine block, the fixed part and the removable part together defining at least one coolant channel and at least one exhaust gas channel of the at least one heat exchanger.

By removably integrating the heat exchanger or “EGR cooler” into the engine block, the fixed part of the heat exchanger is common with the engine block structure. This can reduce the space occupied by the heat exchanger, and the exhaust gas recirculation system as a whole, in comparison to arrangements in which the heat exchanger is provided as a discrete, separate component. This facilitates packaging of the outboard motor and can reduce its overall size and/or weight. Furthermore, by providing a heat exchanger which is removably integrated into the engine block, the removable part of the heat exchanger can be removed from the engine block to facilitate maintenance and servicing of the heat exchanger and allow replacement of the removable part of the heat exchanger independently of the engine block. This can be particularly beneficial for marine applications in which raw water is employed as the coolant fluid, since the presence of salt and/or organisms in raw water can lead to additional fouling and necessitate more frequent cleaning or replacement of cooler components than might otherwise be required.

As used herein, the term “heat exchanger” refers to a device having at least one exhaust gas channel, at least one coolant channel and at least one solid wall by which heat is transferred from exhaust gas in the exhaust gas channel to coolant in the at least one coolant channel in order to cool the exhaust gas. The exhaust gas and coolant are preferably kept separate by the at least one solid wall.

The removable part of the heat exchanger or “EGR cooler” is removably mounted on an external surface of the engine block. This can facilitate access to the heat exchanger. It can also reduce the extent to which the heat exchanger is heated directly by combustion within the engine block in comparison to arrangements in which the heat exchanger is within the engine block. In certain embodiments, the engine block comprises one or more cooling channels, for example as part of a cylinder cooling jacket, and the removable part of the heat exchanger is removably mounted on an external surface of the engine block adjacent to the one or more cooling channels. With this arrangement, the extent to which the heat exchanger is heated directly by combustion can be reduced.

The external surface of the engine block may define a cavity within which the removable part of the at least one heat exchanger is removably received. With this arrangement, the heat exchanger can be at least partially packaged within the confines of the engine block to further reduce the additional space occupied by the heat exchanger. Substantially all of the heat exchanger may be received within the cavity. The external surface may define one or more parts of the heat exchanger.

The external surface of the engine block may comprise a raised flange to which the removable part of the heat exchanger is removably mounted. This can facilitate secure attachment of the heat exchanger to the engine block. The heat exchanger may be removably mounted directly on the raised flange, or indirectly via one or more intermediate components.

The cavity may be defined separately to the raised flange. Preferably, the cavity is at least partly defined by the raised flange. The raised flange may circumscribe the cavity. The raised flange may define substantially all of the side walls of the cavity.

The at least one heat exchanger is removably integrated into the engine block. This means that heat exchanger and the engine block share at least one common component. The at least one heat exchanger comprises a fixed part which is integral to the engine block, and a removable part which is removably mounted to the engine block. The fixed part and the removable part together define at least one coolant channel and at least one exhaust gas channel of the heat exchanger. In this manner, the removable part of the at least one heat exchanger can be removed for maintenance or replacement, while the fixed part remains as an integral part of the engine block.

The at least one coolant channel and the at least one exhaust gas channel may each be enclosed within the fixed and removable parts. The at least one coolant channel may be enclosed within a single one of the fixed and removable parts. The at least one coolant channel may be defined in part by the fixed part and in part by the removable part. Preferably, the fixed part comprises a first surface defining a first portion of the at least one coolant channel and the removable part comprises a second surface defining a second portion of the at least one coolant channel, the first and second surfaces together defining the at least one coolant channel.

Preferably, the fixed part and the removable part are configured such that both of the first and second surfaces are exposed when the removable part is removed from the engine block. With this arrangement, the first and second surfaces, and thus the first and second portions of the at least one coolant channel are made accessible by the removal of the removable part of the engine block. This can facilitate maintenance, servicing and cleaning of the at least one coolant channel. This can be particularly advantageous in marine outboard motors in which raw water is typically used as the coolant fluid and in which the rate of fouling may be higher.

The at least one exhaust gas channel may be enclosed within a single one of the fixed and removable parts. The at least one exhaust gas channel may be defined in part by the fixed part and in part by the removable part. For example, the fixed part may comprise a first surface defining a first portion of the at least one exhaust gas channel and the removable part may comprise a second surface defining a second portion of the at least one exhaust gas channel, the first and second surfaces together defining the at least one exhaust gas channel. In such examples, the fixed part and the removable part may be configured such that both of the first and second surfaces are exposed when the removable part is removed from the engine block. With this arrangement, the first and second surfaces, and thus the first and second portions of the at least one exhaust gas channel are accessible by the removal of the removable part of the engine block. This can facilitate maintenance, servicing and cleaning of the at least one exhaust gas channel.

Preferably, the fixed part forms part of a casting of the engine block.

Preferably, the at least one heat exchanger forms part of a cooling circuit of the internal combustion engine, the cooling circuit having a plurality of coolant channels within the engine block for cooling the at least one cylinder. With this arrangement, it is not necessary for a separate EGR cooling circuit to be provided. This can reduce the weight of the EGR system and the space occupied by the EGR system in the cowl.

The cooling circuit may be configured such that the at least one heat exchanger is downstream of the plurality of coolant channels within the engine block. In such an arrangement, the coolant first cools the at least one cylinder before moving along the cooling circuit to the at least one heat exchanger to cool the exhaust gas. The at least one heat exchanger may be arranged in parallel with one or more of the plurality of coolant channels within the engine block. The at least one heat exchanger may be upstream of one or more of the plurality of coolant channels within the engine block and downstream of one or more of the plurality of coolant channels within the engine block.

The cooling circuit may be configured such that the at least one heat exchanger of the EGR system is upstream of the plurality of coolant channels. In such an arrangement, the coolant first enters the at least one heat exchanger to cool the exhaust gas before moving along the plurality of coolant channels within the engine block to cool the at least one cylinder. This can provide particularly effective cooling of the exhaust gas.

The at least one cylinder may comprise a single cylinder. Preferably, the at least one cylinder comprises a plurality of cylinders.

As used herein, the term “engine block” refers to a solid structure in which the at least one cylinder of the engine is provided. The term may refer to the combination of a cylinder block with a cylinder head and crankcase, or to the cylinder block only. The engine block may be formed from a single engine block casting. The engine block may be formed from a plurality of separate engine block castings which are connected together, for example using bolts.

The engine block may comprise a single cylinder bank.

The engine block may comprise a first cylinder bank and a second cylinder bank. The first and second cylinder banks may be arranged in a V configuration.

The engine block may comprise three cylinder banks. The three cylinder banks may be arranged in a broad arrow configuration. The engine block may comprise four cylinder banks. The four cylinder banks may be arranged in a W or double-V configuration.

Where the engine block comprises a plurality of cylinder banks, the at least one heat exchanger of the EGR system may comprise a single heat exchanger, or a plurality of heat exchangers removably integrated into one or more of the cylinder banks. Where the engine block comprises first and second cylinder banks, the at least one heat exchanger may comprise a first heat exchanger removably integrated into the first cylinder bank and a second heat exchanger removably integrated into the second cylinder bank. The first and second cylinder banks may be arranged in a V configuration with the first and second heat exchangers being located on the outer sides of the V which is formed by the first and second cylinder banks.

The internal combustion engine may be a petrol engine. Preferably, the internal combustion engine is a diesel engine. The internal combustion engine may be a turbocharged diesel engine.

According to a second aspect of the present invention, there is provided a marine vessel comprising the marine outboard motor of the first aspect.

According to a third aspect of the invention, there is provided an internal combustion engine comprising: an engine block; at least one cylinder; an air intake configured to deliver a flow of air to the at least one cylinder; an exhaust conduit configured to direct a flow of exhaust gas from the at least one cylinder; and an exhaust gas recirculation system configured to recirculate a portion of the flow of exhaust gas from the exhaust conduit to the air intake, the exhaust gas recirculation system comprising at least one heat exchanger for cooling recirculated exhaust gas, wherein the at least one heat exchanger comprises a fixed part which is integral to the engine block and a removable part which is removably mounted on an external surface of the engine block, such that the at least one heat exchanger is removably integrated into the engine block , the fixed part and the removable part together defining at least one coolant channel and at least one exhaust gas channel of the at least one heat exchanger.

The advantages associated with the marine outboard motor of the first aspect also apply to the internal combustion engine of the third aspect. These advantages are not exclusive for marine applications but also apply for any application in which an EGR system would be advantageous but in which available space is limited.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. In particular, features of the first aspect of the invention are equally applicable to the internal combustion engine of the third aspect of the invention. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Further features and advantages of the present invention will be further described below, by way of example only, with reference to the accompanying drawings in which:

FIG. 1 is a schematic side view of a light marine vessel provided with a marine outboard motor;

FIG. 2A shows a schematic representation of a marine outboard motor in its tilted position;

FIGS. 2B to 2D show various trimming positions of the marine outboard motor and the corresponding orientation of the marine vessel within a body of water;

FIG. 3 shows a schematic cross-section of a marine outboard motor according to an embodiment of the present invention;

FIG. 4 shows a side view of an internal combustion engine for the marine outboard motor of FIG. 3;

FIG. 5 shows a side view of the internal combustion engine of FIG. 4 in which the exhaust ducting arrangement is not shown;

FIG. 6 shows a cross-section view taken through line VI-VI in FIG. 4;

FIG. 7 shows a perspective side view of the exhaust ducting arrangement of the internal combustion engine of FIG. 4;

FIG. 8 shows a perspective bottom view of a removable part of an EGR cooler of the exhaust ducting arrangement of FIG. 7;

FIG. 9 shows a perspective top view of the removable part of FIG. 8; and

FIG. 10 shows an enlarged cross-section view through line X-X in FIG. 8.

### DETAILED DESCRIPTION

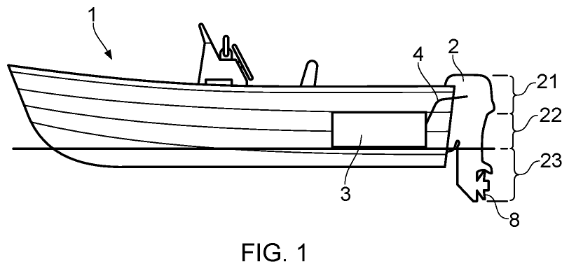

Referring firstly to FIG. 1, there is shown a schematic side view of a marine vessel 1 with a marine outboard motor 2. The marine vessel 1 may be any kind of vessel suitable for use with a marine outboard motor, such as a tender or a scuba-diving boat. The marine outboard motor 2 shown in FIG. 1 is attached to the stern of the vessel 1. The marine outboard motor 2 is connected to a fuel tank 3, usually received within the hull of the marine vessel 1. Fuel from the reservoir or tank 3 is provided to the marine outboard motor 2 via a fuel line 4. Fuel line 4 may be a representation for a collective arrangement of one or more filters, low pressure pumps and separator tanks (for preventing water from entering the marine outboard motor 2) arranged between the fuel tank 3 and the marine outboard motor 2.

As will be described in more detail below, the marine outboard motor 2 is generally divided into three sections, an upper-section 21, a mid-section 22, and a lower-section 23. The mid-section 22 and lower-section 23 are often collectively known as the leg section, and the leg houses the exhaust system. A propeller 8 is rotatably arranged on a propeller shaft at the lower-section 23, also known as the gearbox, of the marine outboard motor 2. Of course, in operation, the propeller 8 is at least partly submerged in water and may be operated at varying rotational speeds to propel the marine vessel 1.

Typically, the marine outboard motor 2 is pivotally connected to the stern of the marine vessel 1 by means of a pivot pin. Pivotal movement about the pivot pin enables the operator to tilt and trim the marine outboard motor 2 about a horizontal axis in a manner known in the art. Further, as is well known in the art, the marine outboard motor 2 is also pivotally mounted to the stern of the marine vessel 1 so as to be able to pivot, about a generally upright axis, to steer the marine vessel 1.

Tilting is a movement that raises the marine outboard motor 2 far enough so that the entire marine outboard motor 2 is able to be raised completely out of the water. Tilting the marine outboard motor 2 may be performed with the marine outboard motor 2 turned off or in neutral. However, in some instances, the marine outboard motor 2 may be configured to allow limited running of the marine outboard motor 2 in the tilt range so as to enable operation in shallow waters. Marine engine assemblies are therefore predominantly operated with a longitudinal axis of the leg in a substantially vertical direction. As such, a crankshaft of an engine of the marine outboard motor 2 which is substantially parallel to a longitudinal axis of the leg of the marine outboard motor 2 will be generally oriented in a vertical orientation during normal operation of the marine outboard motor 2, but may also be oriented in a non-vertical direction under certain operating conditions, in particular when operated on a vessel in shallow water. A crankshaft of a marine outboard motor 2 which is oriented substantially parallel to a longitudinal axis of the leg of the engine assembly can also be termed a vertical crankshaft arrangement. A crankshaft of a marine outboard motor 2 which is oriented substantially perpendicular to a longitudinal axis of the leg of the engine assembly can also be termed a horizontal crankshaft arrangement.

As mentioned previously, to work properly, the lower-section 23 of the marine outboard motor 2 needs to extend into the water. In extremely shallow waters, however, or when launching a vessel off a trailer, the lower-section 23 of the marine outboard motor 2 could drag on the seabed or boat ramp if in the tilted-down position.

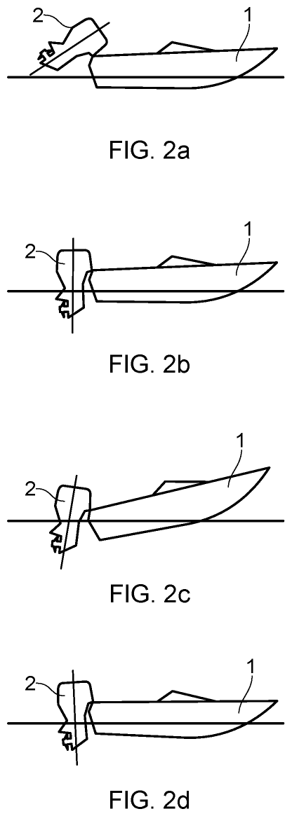

Tilting the marine outboard motor 2 into its tilted-up position, such as the position shown in FIG. 2A, prevents such damage to the lower-section 23 and the propeller 8.

By contrast, trimming is the mechanism that moves the marine outboard motor 2 over a smaller range from a fully-down position to a few degrees upwards, as shown in the three examples of FIGS. 2B to 2D. Trimming helps to direct the thrust of the propeller 8 in a direction that will provide the best combination of fuel efficiency, acceleration and high speed operation of the marine vessel 1.

When the vessel 1 is on a plane (i.e. when the weight of the vessel 1 is predominantly supported by hydrodynamic lift, rather than hydrostatic lift), a bow-up configuration results in less drag, greater stability and efficiency. This is generally the case when the keel line of the boat or marine vessel 1 is up about three to five degrees, such as shown in FIG. 2B for example.

Too much trim-out puts the bow of the vessel 1 too high in the water, such as the position shown in FIG. 2C. Performance and economy, in this configuration, are decreased because the hull of the vessel 1 is pushing the water and the result is more air drag. Excessive trimming-out can also cause the propeller to ventilate, resulting in further reduced performance. In even more severe cases, the vessel 1 may hop in the water, which could throw the operator and passengers overboard.

Trimming-in will cause the bow of the vessel 1 to be down, which will help accelerate from a standing start. Too much trim-in, shown in FIG. 2D, causes the vessel 1 to “plough” through the water, decreasing fuel economy and making it hard to increase speed. At high speeds, trimming-in may even result in instability of the vessel 1.

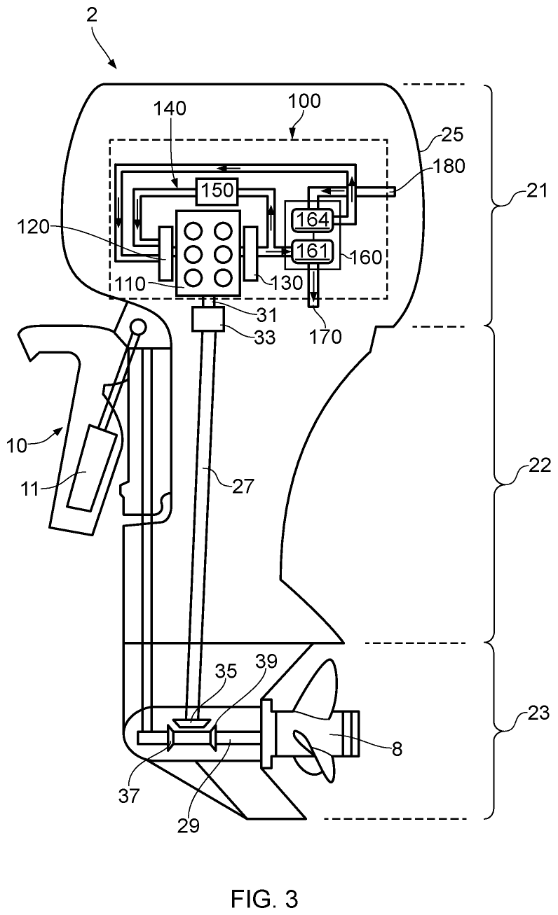

Turning to FIG. 3, there is shown a schematic cross-section of an outboard motor 2 according to an embodiment of the present invention. The outboard motor 2 comprises a tilt and trim mechanism 10 for performing the aforementioned tilting and trimming operations. In this embodiment, the tilt and trim mechanism 10 includes a hydraulic actuator 11 that can be operated to tilt and trim the outboard motor 2 via an electric control system. Alternatively, it is also feasible to provide a manual tilt and trim mechanism, in which the operator pivots the outboard motor 2 by hand rather than using a hydraulic actuator.

As mentioned above, the outboard motor 2 is generally divided into three sections. An upper-section 21, also known as the powerhead, includes an internal combustion engine 100 for powering the marine vessel 1. A cowling 25 is disposed around the engine 100.

Adjacent to, and extending below, the upper-section 21 or powerhead, there is provided a mid-section 22 and a lower section 23. The lower-section 23 extends adjacent to and below the mid-section 22, and the mid-section 22 connects the upper-section 21 to the lower-section 23. The mid-section 22 houses a drive shaft 27 which extends between the combustion engine 100 and the propeller shaft 29 and is connected to a crankshaft 31 of the combustion engine via a floating connector 33 (e.g. a splined connection). At the lower end of the drive shaft 27, a gear box/transmission is provided that supplies the rotational energy of the drive shaft 27 to the propeller 8 in a horizontal direction. In more detail, the bottom end of the drive shaft 27 may include a bevel gear 35 connected to a pair of bevel gears 37, 39 that are rotationally connected to the propeller shaft 29 of the propeller 8.

The mid-section 22 and lower-section 23 form an exhaust system, which defines an exhaust gas flow path for transporting exhaust gases from an exhaust gas outlet 170 of the internal combustion engine 100 and out of the outboard motor 2.

As shown schematically in FIG. 3, the internal combustion engine 100 includes an engine block 110, an air intake manifold 120 for delivering a flow of air to the cylinders in the engine block, and an exhaust manifold 130 configured to direct a flow of exhaust gas from the cylinders. The engine 100 further includes an exhaust gas recirculation (EGR) system 140 configured to recirculate a portion of the flow of exhaust gas from the exhaust manifold 130 to the air intake manifold 120. The EGR system includes a heat exchanger 150, or “EGR cooler”, for cooling recirculated exhaust gas. In this example, the internal combustion engine 100 is turbocharged and so further includes a turbocharger 160 connected to the exhaust manifold 130 and to the air intake manifold 120. In use, exhaust gases are expelled from each cylinder in the engine block 110 and are directed away from the engine block 110 by the exhaust manifold 130. A portion of the exhaust gases are diverted to the heat exchanger 150, while the remaining exhaust gases are delivered from the exhaust manifold 130 to a turbine housing 161 of the turbocharger 160 where they are directed through the turbine before exiting the turbocharger 160 and the engine 100 via the engine exhaust outlet 170. The compressor housing 164 of the turbocharger, which is driven by the spinning turbine, draws in ambient air through an air intake 180 and delivers a flow of pressurised intake air to the air intake manifold 120.

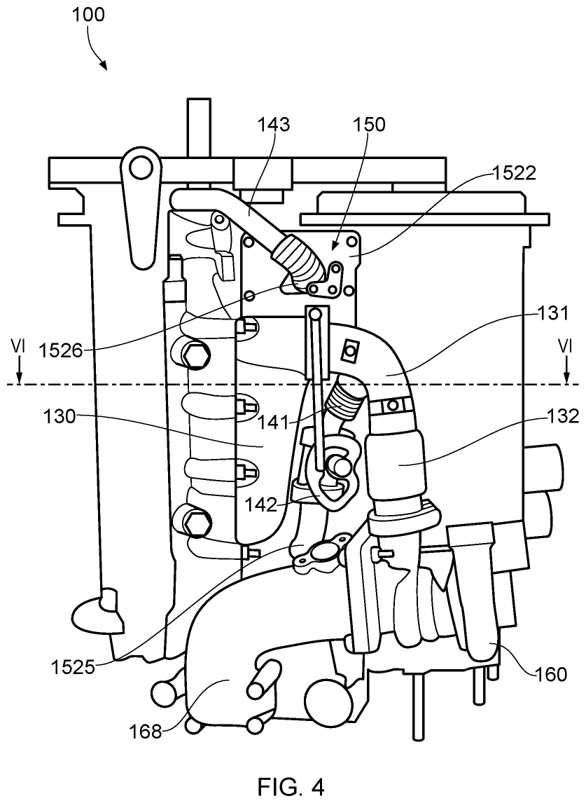

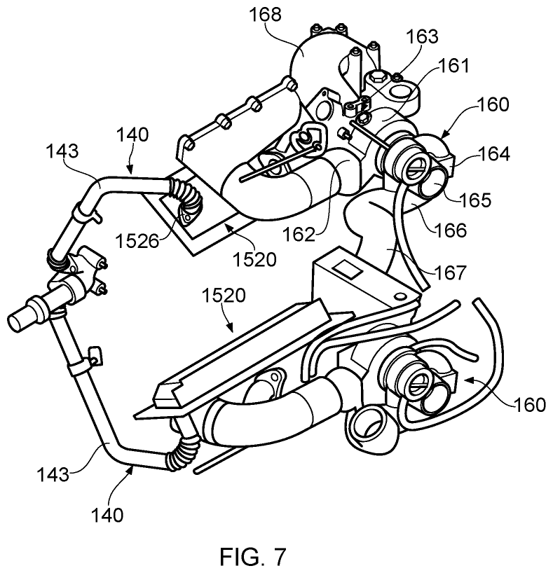

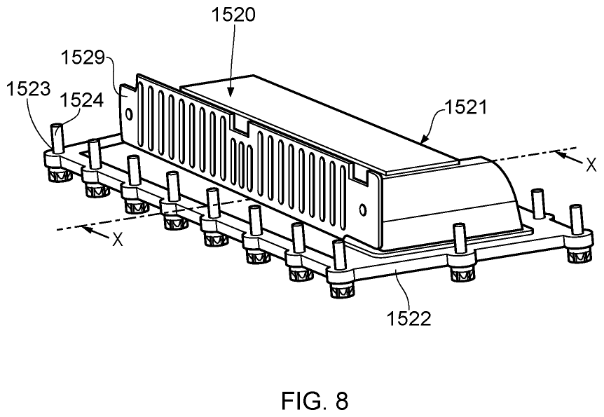

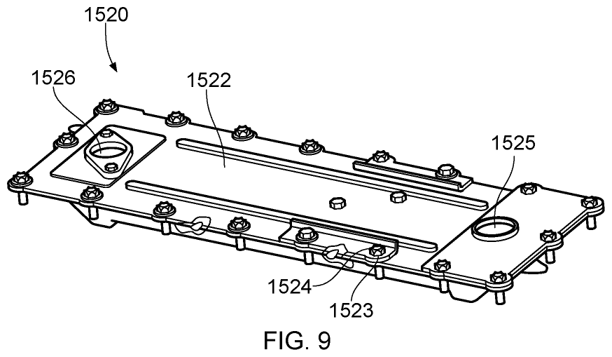

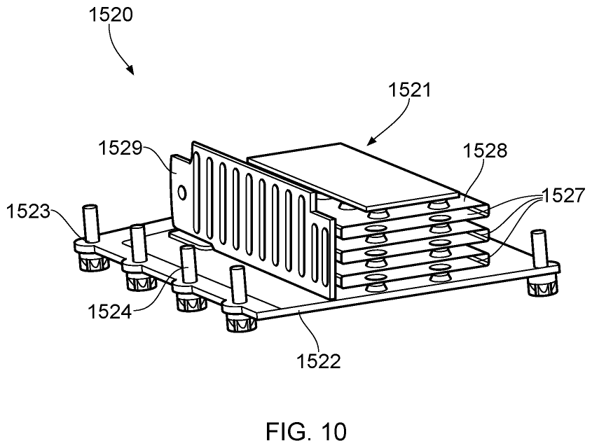

In this example, the engine block 110 comprises first and second cylinder banks arranged in a V configuration and each housing a plurality of cylinders and movable pistons forming combustion chambers within the engine block. With this arrangement, each cylinder bank may have its own intake manifold 120, exhaust manifold 130, and turbocharger 160. Each cylinder bank may also be provided with its own EGR system 140 and dedicated EGR cooler 150 so that the internal combustion engine 100 comprises a pair of EGR coolers 150 and a pair of turbochargers 160. It will be understood that any other amount of cylinders may be employed in the V-shaped cylinder banks. It will also be understood that any other arrangement, such as an in-line arrangement, could alternatively be utilised. In any such example, the engine may comprise one or more of each of the intake manifold 120, exhaust manifold 130, EGR system 140, EGR cooler 150, and turbocharger 160. This is discussed in more detail below with reference to FIGS. 4-10.

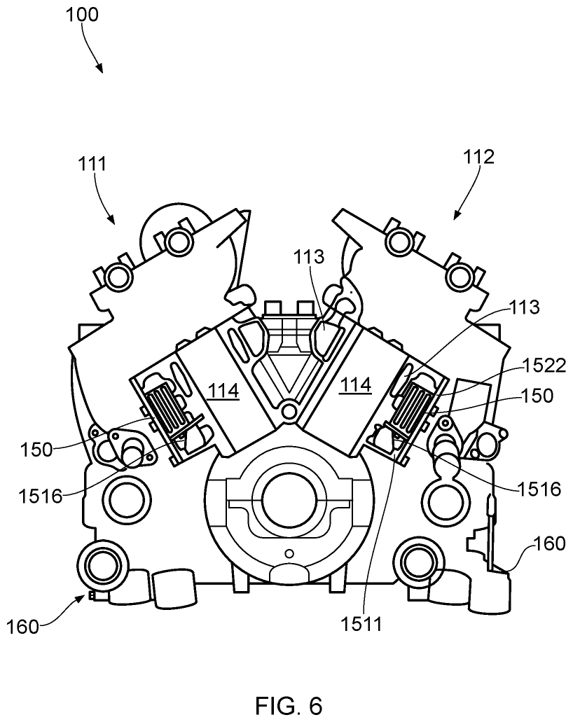

Referring to FIGS. 4-10, the internal combustion engine 100 is shown in more detail. As best seen in FIG. 6, the engine block 110 comprises a first cylinder bank 111 and a second cylinder bank 112. Each cylinder bank may have its own dedicated intake manifold 120, exhaust manifold 130, EGR system 140, EGR cooler 150, and turbocharger 160. For the sake of clarity, the below discussion relates to the arrangement for a single cylinder bank. However, it will be understood that the same arrangement should apply for each cylinder bank.

External to the engine block, an exhaust ducting arrangement is provided to direct exhaust gases away from the engine block 110 to the EGR system 140 and to the turbocharger 160. The exhaust manifold 130 is connected to the turbocharger 160 via an exhaust manifold ducting 131 along which a thermal expansion joint 132 is provided. Branched off from the exhaust manifold ducting 131 at a location upstream of the turbocharger 160 is an EGR hot exhaust duct 141 which extends from the exhaust manifold ducting 131 to the upstream end of the EGR cooler 150. Positioned along the EGR hot exhaust duct 141 is an EGR control valve 142 which regulates the amount of hot exhaust gas diverted from the exhaust manifold ducting 131 to the EGR cooler 150. The EGR cooler 150 is connected at its downstream end to the intake manifold (not shown) by an EGR cooled exhaust duct 143. The EGR cooler 150, or heat exchanger, comprises a fixed part 1510 and a removable part 1520.

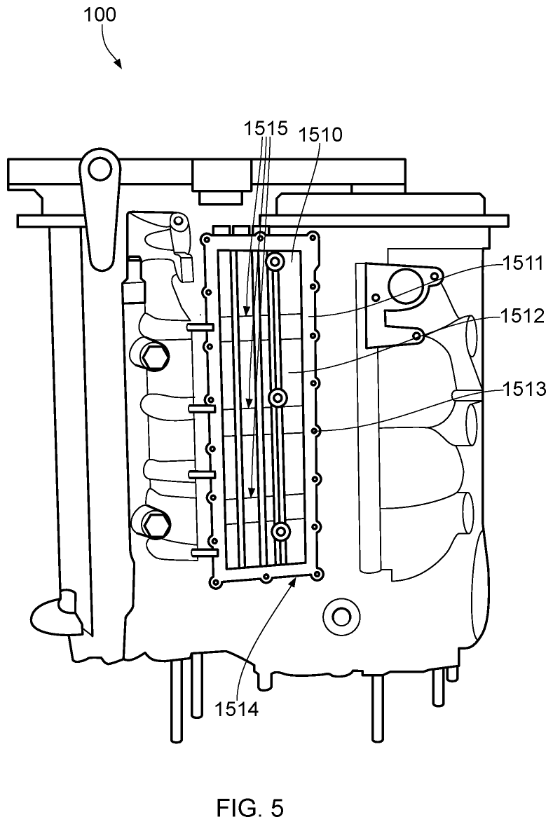

As shown in FIGS. 5 and 6, the fixed part 1510 of the heat exchanger 150 comprises a raised flange 1511 defined on the external surface of the engine block 110. The raised flange 1511 is cast with the rest of the engine block 110 and defines a cavity 1512 within which the removable part 1520 of the heat exchanger 150 is received. The flange 1511 includes a plurality of threaded holes 1513 by which the removable part 1520 may be removably secured to the fixed part 1510. In this manner, the heat exchanger 150 can be said to be removably integrated into the engine block. The fixed part 1510 also includes coolant inlets 1514 and one or more coolant outlets 1515 which extend through the external surface of the engine block 110 and into the cavity 1512.

As shown in FIGS. 4 and 6-10, the removable part 1520 comprises a main body 1521 and a top plate 1522 to which the main body 1521 is fixed. The top plate 1522 includes a plurality of bolt holes 1523 around its periphery through which bolts 1524 are provided to removably secure the removable part 1520 to the threaded holes 1513 in the flange 1511 of the fixed part 1510. The top plate 1522 also includes a hot exhaust inlet 1525 and a cooled exhaust outlet 1526 through which exhaust gas may enter and exit the main body 1521, respectively. Between the hot exhaust inlet 1525 and the cooled exhaust outlet 1526 is an exhaust gas passage defined by a plurality of exhaust gas channels 1527 extending longitudinally along the length of the main body 1521. The exhaust gas channels 1527 are defined by a number of flat, thin-walled heat exchanger tubes 1528 which are stacked in a spaced apart arrangement within the main body 1521. Along both sides of the main body 1521 and adjacent to the tubes 1528 are perforated side walls 1529 through which the heat transfer tubes 1528 are accessible.

As best seen in FIG. 6, when the removable part 1520 of the heat exchanger 150 is received in the cavity defined by the fixed part 1510 of the heat exchanger, the top plate 1522 closes the upper side of the cavity thus forming an enclosed coolant channel 1516 extending between the coolant inlets 1514 and the coolant outlets 1515. The flange 1511, and the external surface of the engine block 110 around which the flange 1511 is provided, thus define a first surface of the coolant channel 1516, while the top plate 1522 thus forms a second surface which together with the first surface defines the coolant channel 1516. In this manner, when the removable part 1520 is removed from the engine block 110, both of the first and second surfaces of the coolant channel 1516 are exposed and can be cleaned more readily. During use, coolant fluid pumped into the coolant channel 1516 via the coolant inlets 1514 is free to pass through the perforated side walls 1529 and around the heat exchanger tubes 1528 before leaving the coolant channel 1516 via the coolant outlets 1515. In this manner, the heat exchanger tubes 1528 encourage heat transfer from exhaust gases in the exhaust gas channels 1527 to coolant fluid in the coolant channel 1516 while preventing fluid contact between the coolant and the exhaust gases. As also shown in FIG. 6, the engine block 110 includes one or more cylinder coolant channels 113 arranged around one or more of the cylinders 114 in order to cool the cylinders 114 during use. The cylinder coolant channels 113 form part of an engine cooling circuit including a pump (not shown) which is positioned lower in the leg of the outboard motor and which draws raw water from the body of water on which the outboard motor is used and pumps it to and from the cylinder coolant channels 113 via a number of coolant ducts (not shown). The EGR coolers 150 may be provided with coolant fluid in a similar manner by their own dedicated pump. In this example, the heat exchanger 150 forms part of the engine cooling circuit such that raw water is pumped first to the EGR coolers 150 before being pumped to the cylinder coolant channels.

The turbocharger 160 is formed from a turbine housing 161 having a turbine inlet 162 and a turbine outlet 163, and a compressor housing 164 having a compressor inlet 165 and a compressor outlet 166. The compressor inlet 165 is connected to an air filter (not shown) via an air inlet duct (not shown). The compressor outlet 166 is connected to the air intake manifold 120 via charge ducting 167. In the illustrated embodiment, the charge ducting 167 is provided as a flexible hose. In this way, filtered air is able to flow into the compressor 164 so as to be compressed therein prior to entering the cylinders. Following combustion in the cylinders within the engine block 110, exhaust gases pass to the exhaust manifold 130, which is configured to deliver exhaust gas to the turbine inlet 162. In this way, the exhaust gas expelled from the engine block 110 is used to drive a turbine of the turbocharger 160 so as to drive the compressor. In the illustrated embodiment, the turbocharger 160 is connected to the exhaust manifold 130 via an exhaust manifold ducting 131. The ducting 131 includes a thermal expansion joint 132 such that the turbocharger 160 is connected to the exhaust manifold 130 via the thermal expansion joint 132. After driving the turbine of the turbocharger 160, the exhaust gas flows out of the turbine housing 161 via a turbocharger exhaust conduit 168 so as to be directed to the one or more gas outlets of the outboard motor 2.

Although the invention has been described above with reference to one or more preferred embodiments, it will be appreciated that various changes or modifications may be made without departing from the scope of the invention as defined in the appended claims.

The present invention may also be described or defined in accordance with the following clauses:

1. A marine outboard motor having an internal combustion engine, the internal combustion engine comprising:

an engine block;

at least one cylinder;

an air intake configured to deliver a flow of air to the at least one cylinder;

an exhaust conduit configured to direct a flow of exhaust gas from the at least one cylinder; and

an exhaust gas recirculation system configured to recirculate a portion of the flow of exhaust gas from the exhaust conduit to the air intake, the exhaust gas recirculation system comprising a heat exchanger for cooling recirculated exhaust gas, wherein the heat exchanger is removably integrated into the engine block.

2. The marine outboard motor of clause 1, wherein at least part of the heat exchanger is removably mounted on an external surface of the engine block.

3. The marine outboard motor of clause 2, wherein the external surface of the engine block defines a cavity within which at least part of the heat exchanger is removably received.

4. The marine outboard motor of clause 3, wherein the external surface of the engine block comprises a raised flange to which at least part of the heat exchanger is removably mounted.

5. The marine outboard motor of clause 4, wherein the cavity is defined by the raised flange.

6. The marine outboard motor of any of clauses 2 to 5, wherein the heat exchanger comprises a fixed part which is integral to the engine block, and a removable part which is removably mounted to the engine block, the fixed part and the removable part together defining at least one coolant channel and at least one exhaust gas channel of the heat exchanger.

7. The marine outboard motor of clause 6, wherein the fixed part comprises a first surface defining a first portion of the at least one coolant channel and the removable part comprises a second surface defining a second portion of the at least one coolant channel, the first and second surfaces together defining the at least one coolant channel.

8. The marine outboard motor of clause 7, wherein the fixed part and the removable part are configured such that both of the first and second surfaces are exposed when the removable part is removed from the engine block.

9. The marine outboard motor of any of clauses 6 to 8, wherein the fixed part forms part of a casting of the engine block.

10. The marine outboard motor of any preceding clause, wherein the heat exchanger forms part of a cooling circuit of the internal combustion engine, the cooling circuit having a plurality of coolant channels within the engine block for cooling the at least one cylinder.

11. The marine outboard motor of clause 10, wherein the cooling circuit is configured such that the heat exchanger of the exhaust gas recirculation system is upstream of the plurality of coolant channels.

12. The marine outboard motor of any preceding clause, wherein the engine block comprises a first cylinder bank and a second cylinder bank.

13. The marine outboard motor of clause 12, wherein the heat exchanger comprises a first heat exchanger removably integrated into the first cylinder bank and a second heat exchanger removably integrated into the second cylinder bank.

14. The marine outboard motor of any of clauses 1 to 13, wherein the internal combustion engine is a diesel engine, preferably a turbo-charged diesel engine.

15. A marine vessel comprising the marine outboard motor of any of clauses 1 to 14.

16. An internal combustion engine comprising:

an engine block;

at least one cylinder;

an air intake configured to deliver a flow of air to the at least one cylinder;

an exhaust conduit configured to direct a flow of exhaust gas from the at least one cylinder; and

an exhaust gas recirculation system configured to recirculate a portion of the flow of exhaust gas from the exhaust conduit to the air intake, the exhaust gas recirculation system comprising a heat exchanger for cooling recirculated exhaust gas, wherein the heat exchanger is removably integrated into the engine block.

1. A marine outboard motor having an internal combustion engine, the internal combustion engine comprising:
an engine block;
at least one cylinder;
an air intake configured to deliver a flow of air to the at least one cylinder;
an exhaust conduit configured to direct a flow of exhaust gas from the at least one cylinder; and
an exhaust gas recirculation system configured to recirculate a portion of the flow of exhaust gas from the exhaust conduit to the air intake, the exhaust gas recirculation system comprising at least one heat exchanger for cooling recirculated exhaust gas, wherein the at least one heat exchanger comprises a fixed part which is integral to the engine block and a removable part which is removably mounted on an external surface of the engine block, such that the at least one heat exchanger is removably integrated into the engine block, the fixed part and the removable part together defining at least one coolant channel and at least one exhaust gas channel of the at least one heat exchanger.

2. (canceled)

3. The marine outboard motor of claim 1, wherein the external surface of the engine block defines a cavity within which the removable part of the at least one heat exchanger is removably received.

4. The marine outboard motor of claim 3, wherein the external surface of the engine block comprises a raised flange to which the removable part of the at least one heat exchanger is removably mounted.

5. The marine outboard motor of claim 4, wherein the cavity is defined by the raised flange.

6. The marine outboard motor of claim 1, wherein the at least one coolant channel is enclosed within a single one of the fixed and removable parts.

7. The marine outboard motor of claim 1, wherein the fixed part comprises a first surface defining a first portion of the at least one coolant channel and the removable part comprises a second surface defining a second portion of the at least one coolant channel, the first and second surfaces together defining the at least one coolant channel.

8. The marine outboard motor of claim 7, wherein the fixed part and the removable part are configured such that both of the first and second surfaces are exposed when the removable part is removed from the engine block.

9. The marine outboard motor of claim 1, wherein the fixed part forms part of a casting of the engine block.

10. The marine outboard motor of claim 1, wherein the at least one heat exchanger forms part of a cooling circuit of the internal combustion engine, the cooling circuit having a plurality of coolant channels within the engine block for cooling the at least one cylinder.

11. The marine outboard motor of claim 10, wherein the cooling circuit is configured such that the heat exchanger of the exhaust gas recirculation system is upstream of the plurality of coolant channels.

12. The marine outboard motor of claim 1, wherein the engine block comprises a first cylinder bank and a second cylinder bank.

13. The marine outboard motor of claim 12, wherein the at least one heat exchanger comprises a first heat exchanger removably integrated into the first cylinder bank and a second heat exchanger removably integrated into the second cylinder bank.

14. The marine outboard motor of claim 1, wherein the internal combustion engine is a turbo-charged diesel engine.

15. A marine vessel comprising the marine outboard motor of claim 1.

16. An internal combustion engine comprising:
an engine block;
at least one cylinder;
an air intake configured to deliver a flow of air to the at least one cylinder;
an exhaust conduit configured to direct a flow of exhaust gas from the at least one cylinder; and
an exhaust gas recirculation system configured to recirculate a portion of the flow of exhaust gas from the exhaust conduit to the air intake, the exhaust gas recirculation system comprising at least one a heat exchanger for cooling recirculated exhaust gas, wherein the at least one heat exchanger comprises a fixed part which is integral to the engine block and a removable part which is removably mounted on an external surface of the engine block, such that the at least one heat exchanger is removably integrated into the engine block, the fixed part and the removable part together defining at least one coolant channel and at least one exhaust gas channel of the at least one heat exchanger.
